(19) United States
(12) Patent Application Publication
(10) Pub. No.: US 2013/0110443 A1
(43) Pub. Date: May 2, 2013

(54) GRANTING AUTHORITY IN RESPONSE TO DEFECT DETECTION

(71) Applicants: Cary L. Bates, Rochester, MN (US); Nicholas P. Johnson, Rochester, MN (US); Justin K. King, Rochester, MN (US); Lee Nee, Rochester, MN (US); Siobhan M. O'Toole, Seattle, WA (US)

(72) Inventors: Cary L. Bates, Rochester, MN (US); Nicholas P. Johnson, Rochester, MN (US); Justin K. King, Rochester, MN (US); Lee Nee, Rochester, MN (US); Siobhan M. O'Toole, Seattle, WA (US)

(73) Assignee: INTERNATIONAL BUSINESS MACHINES CORPORATION, Armonk, NY (US)

(21) Appl. No.: 13/281,599

(22) Filed: Oct. 26, 2011

(51) Int. Cl. G06F 19/00

(52) U.S. Cl. 702/108

(57) ABSTRACT

A method, computer-readable storage medium, and computer system are provided. In an embodiment, a defect is detected in a product. In response to detecting the defect in the product, a part is created that describes the state of execution of the product at a time that the defect was detected. In response to creating the part that describes state of the execution of the product at the time that the defect was detected, authority is granted to access the part to a first user who is responsible for fixing the defect.

### FIELD

An embodiment of the invention generally relates to computer systems and more particularly to computer systems that grant authority to access parts.

### BACKGROUND

Computer systems typically comprise a combination of computer programs and hardware, such as semiconductors, transistors, chips, circuit boards, storage devices, and processors. The computer programs are stored in the storage devices and are executed by the processors.

Computer programs are typically tested to ensure that they operate as intended using test programs. The test programs execute, send data to the program under test, and compare the received response from the program under test to an expected response. If the received response does not equal the expected response, then the computer program has an error or a defect, also known as a bug. The user responsible for testing the program then collects data regarding the test that was performed and the state of the program at the time the error occurred and sends the data to a developer who is responsible for fixing the defect.

### SUMMARY

A method, computer-readable storage medium, and computer system are provided. In an embodiment, a defect is detected in a product. In response to detecting the defect in the product, a part is created that describes the state of execution of the product at a time that the defect was detected. In response to creating the part that describes state of the execution of the product at the time that the defect was detected, authority is granted to access the part to a first user who is responsible for fixing the defect.

### BRIEF DESCRIPTION OF THE SEVERAL VIEWS OF THE DRAWINGS

FIG. 1 depicts a high-level block diagram of an example system for implementing an embodiment of the invention.

FIG. 2 depicts a block diagram of an example data structure for team data, according to an embodiment of the invention.

FIG. 3 depicts a block diagram of an example data structure for authorization data, according to an embodiment of the invention.

FIG. 4 depicts a flowchart of example processing for opening a defect, according to an embodiment of the invention.

FIG. 5 depicts a flowchart of example processing for accessing a part, according to an embodiment of the invention.

FIG. 6 depicts a flowchart of example processing for delegating authority, according to an embodiment of the invention.

FIG. 7 depicts a flowchart of example processing for a defect fixed command, according to an embodiment of the invention.

It is to be noted, however, that the appended drawings illustrate only example embodiments of the invention, and are therefore not considered a limitation of the scope of other embodiments of the invention.

### DETAILED DESCRIPTION

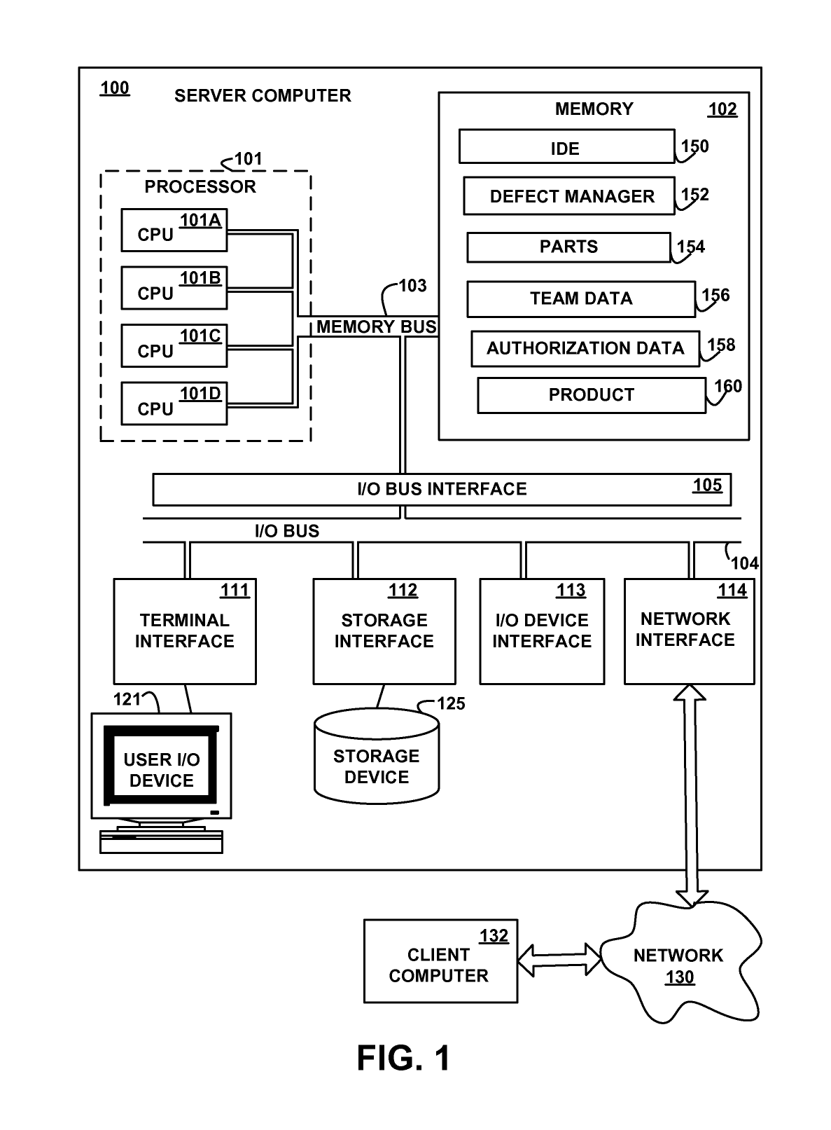

Referring to the Drawings, wherein like numbers denote like parts throughout the several views, FIG. 1 depicts a high-level block diagram representation of a server computer system 100 connected to a client computer system 132 via a network 130, according to an embodiment of the present invention. The terms “server” and “client” are used herein for convenience only, and in various embodiments a computer system that operates as a client computer in one environment may operate as a server computer in another environment, and vice versa. The mechanisms and apparatus of embodiments of the present invention apply equally to any appropriate computing system.

The major components of the computer system 100 comprise one or more processors 101, a main memory 102, a terminal interface 111, a storage interface 112, an I/O (Input/Output) device interface 113, and a network adapter 114, all of which are communicatively coupled, directly or indirectly, for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may comprise one or more levels of on-board cache.

In an embodiment, the main memory 102 may comprise a random-access semiconductor memory, storage device, or storage medium for storing or encoding data and programs. The memory 102 may be volatile, non-volatile, or a combination of volatile and non-volatile storage devices. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes an IDE (Integrated Development Environment) 150, a defect manager 152, parts 154, team data 156, authorization data 158, and a product 160. Although the IDE 150, the defect manager 152, the parts 154, the team data 156, the authorization data 158, and the product 160 are illustrated as being contained within the memory 102 in the computer system 100, in other embodiments some or all of them may be on different computer systems, e.g., the client computer 132, and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the IDE 150, the defect manager 152, the parts 154, the team data 156, the authorization data 158, and the product 160 are illustrated as being contained within the main memory 102, these elements are not necessarily all completely contained in the same storage device at the same time. Further, although the IDE 150, the defect manager 152, the parts 154, the team data 156, the authorization data 158, and the product 160 are illustrated as being separate entities, in other embodiments some of them, portions of some of them, or all of them may be packaged together.

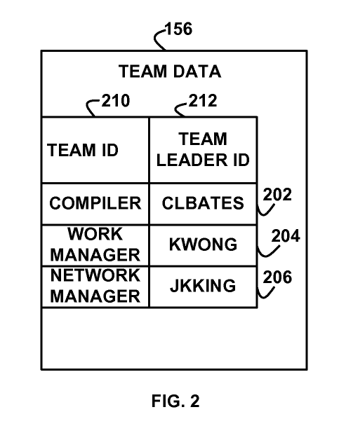

In an embodiment, the IDE 150, the defect manager 152, the parts 154, and/or the product 160 comprise instructions or statements that execute on the processor 101 or instructions or statements that are interpreted by instructions or statements that execute on the processor 101, to carry out the functions as further described below with reference to FIGS. 2, 3, 4, 5, 6, and 7. In another embodiment, the IDE 150, the defect manager 152, the parts 154, and/or the product 160 are implemented in hardware via semiconductor devices, chips, logical gates, circuits, circuit cards, and/or other physical hardware devices in lieu of, or in addition to, a processor-based system. In an embodiment, the IDE 150, the defect manager 152, the parts 154, and/or the product 160 comprise data in addition to instructions or statements.

In various embodiments, the product 160 is an operating system, a user application, a third-party application, a computer program, or any portion, multiple, or combination thereof. The IDE 150 tests or debugs the product 160 to find a defect or defects in the product 160. A defect is an error or problem in the product 160 and represents a discrepancy between an actual result, behavior, or function of the product 160 and an expected result, behavior, or function. The IDE 150 tests the product 160 by executing the product 160, sending or providing input data to the product 160, and comparing the actual output data from the product 160 to the expected output data. The IDE 150 creates the parts 154 as a result of the defect. The parts 154 comprise data that describes or characterizes the defect and the state of the product 160 at the time that the IDE 150 detected the defect. In various embodiments, data in the parts 154 that describes the defect may comprise test programs, input data to the product 160, data expected to be received from the product 160 in response to the input data, actual data received from the product in response to the input data, or any combination or multiple thereof. In various embodiments, the state of the product in the parts 154 may comprise an identifier of the instruction in the product 160 that was executed at the time the defect was encountered, the contents of the invocation stack of the product 160 at the time the defect was encountered, the contents of variables, registers, or other memory locations used by the product 160 at the time or during a time period before the defect was encountered, trace data that describes the executions or contents of memory during a time period before the defect was encountered, or any combination or multiple thereof.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104.

The I/O interface units support communication with a variety of storage and I/O devices. For example, the terminal interface unit 111 supports the attachment of one or more user I/O devices 121, which may comprise user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 121 and the computer system 100, and may receive output data via the user output devices. For example, a user interface may be presented via the user I/O device 121, such as displayed on a display device, played via a speaker, or printed via a printer.

The storage interface unit 112 supports the attachment of one or more disk drives or direct access storage devices 125 (which are typically rotating magnetic disk drive storage devices, although they could alternatively be other storage devices, including arrays of disk drives configured to appear as a single large storage device to a host computer). In another embodiment, the storage device 125 may be implemented via any type of secondary storage device. The contents of the main memory 102, or any portion thereof, may be stored to and retrieved from the storage device 125, as needed. The I/O device interface 113 provides an interface to any of various other input/output devices or devices of other types, such as printers or fax machines. The network adapter 114 provides one or more communications paths from the computer system 100 to other digital devices and computer systems 132; such paths may comprise, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 is implemented as a desktop computer, portable computer, laptop or notebook computer, tablet computer, pocket computer, telephone, smart phone, pager, automobile, teleconferencing system, appliance, or any other appropriate type of electronic device.

The network 130 may be any suitable network or combination of networks and may support any appropriate protocol suitable for communication of data and/or code to/from the computer system 100 and the computer system 132. In various embodiments, the network 130 may represent a storage device or a combination of storage devices, either connected directly or indirectly to the computer system 100. In another embodiment, the network 130 may support wireless communications. In another embodiment, the network 130 may support hard-wired communications, such as a telephone line or cable. In another embodiment, the network 130 may be the Internet and may support IP (Internet Protocol). In another embodiment, the network 130 is implemented as a local area network (LAN) or a wide area network (WAN). In another embodiment, the network 130 is implemented as a hotspot service provider network. In another embodiment, the network 130 is implemented as an intranet. In another embodiment, the network 130 is implemented as any appropriate cellular data network, cell-based radio network technology, or wireless network. In another embodiment, the network 130 is implemented as any suitable network or combination of networks. Although one network 130 is shown, in other embodiments any number of networks (of the same or different types) may be present.

The computer system 132 may comprise some or all of the hardware and/or computer program elements of the computer system 100.

FIG. 1 is intended to depict the representative major components of the computer system 100, the network 130, and the computer system 132. But, individual components may have greater complexity than represented in FIG. 1, components other than or in addition to those shown in FIG. 1 may be present, and the number, type, and configuration of such components may vary. Several particular examples of such additional complexity or additional variations are disclosed herein; these are by way of example only and are not necessarily the only such variations. The various program components illustrated in FIG. 1 and implementing various embodiments of the invention may be implemented in a number of manners, including using various computer applications, routines, components, programs, objects, modules, data structures, etc., and are referred to hereinafter as “computer programs,” or simply “programs.”

The computer programs comprise one or more instructions or statements that are resident at various times in various memory and storage devices in the computer system 100 and that, when read and executed by one or more processors in the computer system 100 or when interpreted by instructions that are executed by one or more processors, cause the computer system 100 to perform the actions necessary to execute steps or elements comprising the various aspects of embodiments of the invention. Aspects of embodiments of the invention may be embodied as a system, method, or computer program product. Accordingly, aspects of embodiments of the invention may take the form of an entirely hardware embodiment, an entirely program embodiment (including firmware, resident programs, micro-code, etc., which are stored in a storage device) or an embodiment combining program and hardware aspects that may all generally be referred to herein as a “circuit,” “module,” or “system.” Further, embodiments of the invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium, may be, for example, but not limited to, an electronic, magnetic, optical, electromagnetic, infrared, or semiconductor system, apparatus, or device, or any suitable combination of the foregoing. More specific examples (an non-exhaustive list) of the computer-readable storage media may comprise: an electrical connection having one or more wires, a portable computer diskette, a hard disk (e.g., the storage device 125), a random access memory (RAM) (e.g., the memory 102), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may comprise a propagated data signal with computer-readable program code embodied thereon, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagates, or transports a program for use by, or in connection with, an instruction execution system, apparatus, or device. Program code embodied on a computer-readable medium may be transmitted using any appropriate medium, including but not limited to, wireless, wire line, optical fiber cable, Radio Frequency, or any suitable combination of the foregoing.

Computer program code for carrying out operations for aspects of embodiments of the present invention may be written in any combination of one or more programming languages, including object oriented programming languages and conventional procedural programming languages. The program code may execute entirely on the user's computer, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments of the invention are described below with reference to flowchart illustrations and/or block diagrams of methods, apparatus (systems), and computer program products. Each block of the flowchart illustrations and/or block diagrams, and combinations of blocks in the flowchart illustrations and/or block diagrams may be implemented by computer program instructions embodied in a computer-readable medium. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified by the flowchart and/or block diagram block or blocks. These computer program instructions may also be stored in a computer-readable medium that can direct a computer, other programmable data processing apparatus, or other devices to function in a particular manner, such that the instructions stored in the computer-readable medium produce an article of manufacture, including instructions that implement the function/act specified by the flowchart and/or block diagram block or blocks.

The computer programs defining the functions of various embodiments of the invention may be delivered to a computer system via a variety of tangible computer-readable storage media that may be operatively or communicatively connected (directly or indirectly) to the processor or processors. The computer program instructions may also be loaded onto a computer, other programmable data processing apparatus, or other devices to cause a series of operational steps to be performed on the computer, other programmable apparatus, or other devices to produce a computer-implemented process, such that the instructions, which execute on the computer or other programmable apparatus, provide processes for implementing the functions/acts specified in the flowcharts and/or block diagram block or blocks.

The flowchart and the block diagrams in the figures illustrate the architecture, functionality, and operation of possible implementations of systems, methods, and computer program products, according to various embodiments of the present invention. In this regard, each block in the flowcharts or block diagrams may represent a module, segment, or portion of code, which comprises one or more executable instructions for implementing the specified logical function(s). In some embodiments, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flow chart illustrations, can be implemented by special purpose hardware-based systems that perform the specified functions or acts, in combinations of special purpose hardware and computer instructions.

Embodiments of the invention may also be delivered as part of a service engagement with a client corporation, nonprofit organization, government entity, or internal organizational structure. Aspects of these embodiments may comprise configuring a computer system to perform, and deploying computing services (e.g., computer-readable code, hardware, and web services) that implement, some or all of the methods described herein. Aspects of these embodiments may also comprise analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention are not limited to use solely in any specific application identified and/or implied by such nomenclature. The exemplary environments illustrated in FIG. 1 are not intended to limit the present invention. Indeed, other alternative hardware and/or program environments may be used without departing from the scope of embodiments of the invention.

FIG. 2 depicts a block diagram of an example data structure for team data 156, according to an embodiment of the invention. The team data 156 comprises any number of example entries 202, 204, and 206, each of which comprises an example team identifier field 210, and an team leader identifier field 212. The team identifier field 210 identifies a team or group, to which a plurality of team members belong. The team leader identifier 212 identifies a group member and leader of the team identified by the team identified 210 in the same entry. The team data 156 may also identify other members of each team. The team leader may delegate authority to access parts to other team members.

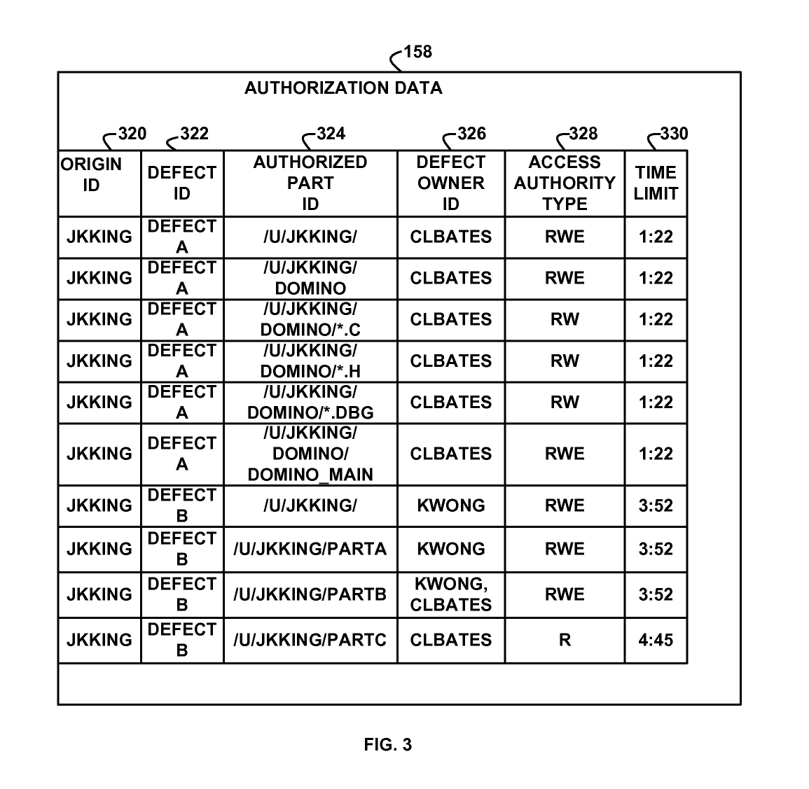

FIG. 3 depicts a block diagram of an example data structure for authorization data 158, according to an embodiment of the invention. The authorization data 158 comprises any number of example entries, each of which comprises an example origin identifier field 320, defect identifier field 322, authorized part identifier field 324, defect owner identifier field 326, access authority type field 328, and time limit field 330.

The origin identifier field 320 identifies a user who detected the defect in the product 160, who created the parts identified by the authorized part identifier field 324, who requested that the IDE 150 create the parts identified by the authorized part identifier field 324, who owns the parts identified by the authorized part identifier field 324, or any combination thereof. The defect identifier field 322 identifies a defect, error, or problem in the product 160. The authorized part identifier field 324 identifies a part or parts to which the defect owner identified by the defect owner identifier 326, in the same entry, is grated the access authority specified by the access authority type 328 in the same entry for the time period specified by the time limit 330, in the same entry. In various embodiments, the authorized part identifier 324 may comprise a network address, path, directory, sub-directory, drive, class, object, module, procedure, sub-procedure, file, or any combination thereof.

The defect owner identifier field 326 specifies a user who is granted authority, by virtue of the entry, to access the part identified by the authorized part identifier field 324 and is responsible for fixing the defect identified by the defect identifier 322 in the same entry or who is responsible for delegating authority to access the part to another user. In an embodiment, the defect owner identifier field 326 and the origin identifier field 320, in the same entry, specify different users.

The access authority type field 328 specifies the type of access authority granted to the defect owner ID 326 to the authorized part identifier 324, in the same entry. In various embodiments, the access authority type 328 may specify a read access, a write access, an update access, a erase access, or any combination thereof. The time limit field 330 specifies the period of time, measured starting from the time that access authority is granted, that the defect owner 326 is authorized to access the part 324. After expiration of the time period specified by the time limit field 330, the defect manager 152 revokes the authorization.

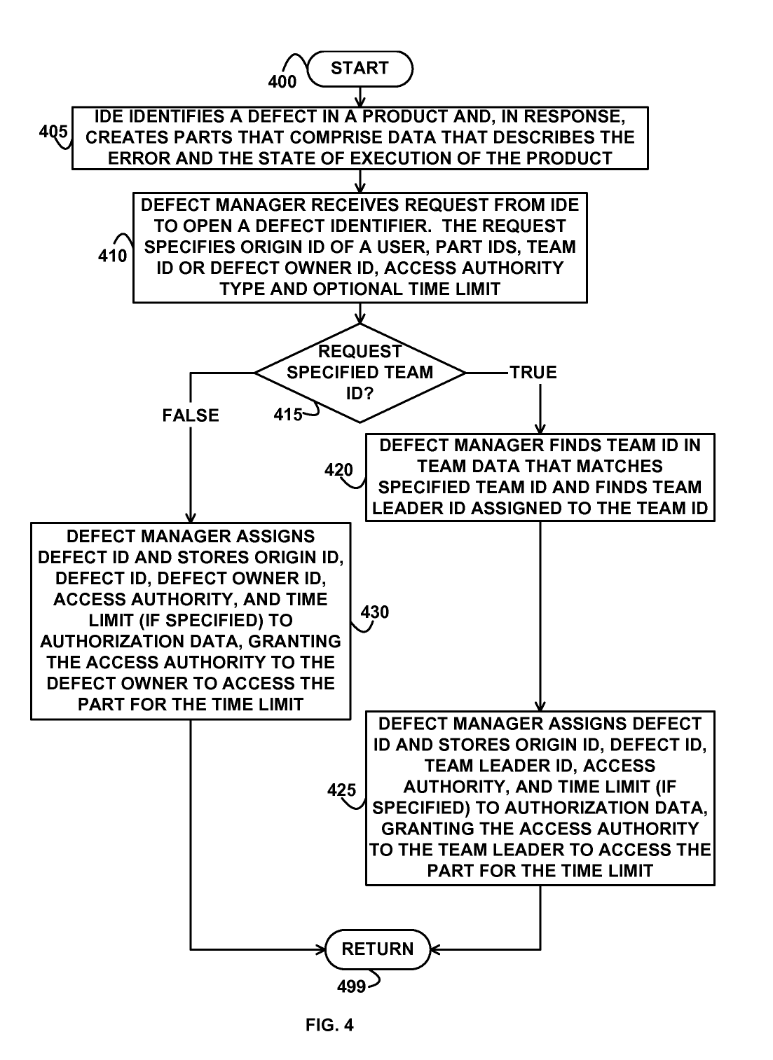

FIG. 4 depicts a flowchart of example processing for opening a defect, according to an embodiment of the invention. Control begins at block 400. Control then continues to block 405 where the IDE 150 identifies a defect in the product 160 and, in response, creates and stores parts to memory that comprise data that describes the defect and the state of execution of the product 160 on the processor 101. In an embodiment, the IDE 150 identifies the defect by executing test programs that send input data to the product 160, receive output data from the product 160, and compare the received output data to expected output data. If the received output data does not match (is not equal to) the expected output data, the IDE 150 has identified a defect in the product 160. If the received output data matches (is equal to) the expected output data, the IDE 150 has not identified a defect in the product 160. The creation and storing of the parts to memory is in response to, is the result of, or was caused by the identification of the defect.

Control then continues to block 410 where the defect manager 152 receives a request from the IDE 150 to open a defect. The request specifies an origin identifier of a user, part identifiers of the parts that comprise the data that describes defect and the state of execution of the product 160, a team identifier or defect owner identifier, an access authority type, and an optional time limit. The IDE 150 sends request to open the defect in response to, as the result of, or as caused by the identification of the defect and the creation and the storing of the parts to the memory 102.

Control then continues to block 415 where the defect manager 152 determines whether the open request specified a team identifier. If the determination at block 415 is true, then the open request specified a team identifier, so control continues to block 420 where the defect manager 152 finds an entry with a team identifier 210 in the team data 156 that matches (is identical to) the team identifier specified by the open request and finds a team leader identifier 212 in the same entry in the team data 156 that is assigned to the found team identifier, that is a leader of the team identified by the team identifier, or is a member of the team specified by the team identifier, by reading the team leader identifier 212 from the same entry as the found team identifier 210 that matches the team identifier specified by the open request.

Control then continues to block 425 where the defect manager 152 assigns a defect identifier to the defect and stores the origin identifier, the defect identifier, the team leader identifier, the access authority, and the time limit (if specified) to an entry in the authorization data 158, granting the requested access authority to the team leader to access the part for a time period specified by the time limit In an embodiment, the defect manager 152 assigns defect identifiers sequentially, in the order that open requests are received, but in other embodiments any appropriate technique may be used for assigning defect identifiers. Control then continues to block 499 where the logic of FIG. 4 returns.

If the determination at block 415 is false, then the open request specified a defect owner identifier, so control continues to block 430 where the defect manager 152 assigns a defect identifier and stores the origin identifier, the defect identifier, the defect owner identifier, the access authority, and the time limit (if specified) to an entry in the authorization data 158, granting the access authority to the defect owner to access the part for the time period specified by the time limit. Control then continues to block 499 where the logic of FIG. 4 returns.

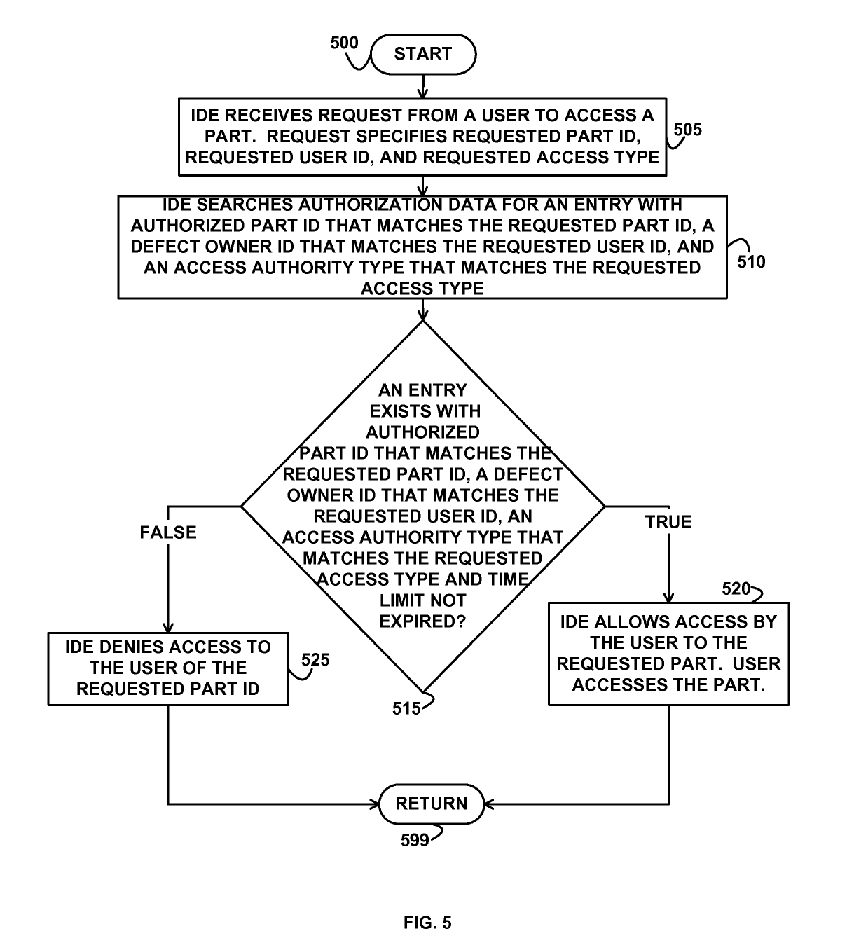

FIG. 5 depicts a flowchart of example processing for accessing a part, according to an embodiment of the invention. Control begins at block 500. Control then continues to block 505 where the IDE 150 receives request from a user to access a part. The request specifies a requested part identifier, a requested user identifier that identifies the user who desires to access the part identified by the part identifier, and a requested access type that specifies the type of access that the user desires to the part.

Control then continues to block 510 where the IDE 150 searches the authorization data 158 for an entry with an authorized part identifier 324 that matches the requested part identifier, a defect owner identifier 326 that matches the requested user identifier, and an access authority type 328 that matches the requested access type.

Control then continues to block 515 where the IDE 150 determines whether an entry in the authorization data 158 exists with an authorized part identifier 324 that matches the requested part identifier, a defect owner identifier 326 that matches the requested user identifier, an access authority type 328 that matches the requested access type and the time limit 330 (if it exists in the matching entry in the authorization data 158) has not ended or been exceeded since the time that the authority represented by the matching entry in the authorization data 158 was granted.

If the determination at block 515 is true, then an entry in the authorization data 158 exists with an authorized part identifier 324 that matches the requested part identifier, a defect owner identifier 326 that matches the requested user identifier, an access authority type 328 that matches the requested access type and the time limit 330 (if it exists in the matching entry in the authorization data 158) has not ended or been exceeded since the time that the authority represented by the matching entry in the authorization data 158 was granted, so control continues to block 520 where the IDE 150 allows access by the user to the requested part, and the user accesses the requested part using the access authority type. Control then continues to block 599 where the logic of FIG. 5 returns.

If the determination at block 515 is false, then an entry in the authorization data 158 does not exist with an authorized part identifier 324 that matches the requested part identifier, or a defect owner identifier 326 does not match the requested user identifier, or an access authority type 328 does not match the requested access type, or the time limit 330 (if it exists in the matching entry in the authorization data 158) has ended or been exceeded since the time that the authority represented by the matching entry in the authorization data 158 was granted, so control continues to block 525 where the IDE 150 denies the user access to the part identified by the requested part identifier. Control then continues to block 599 where the logic of FIG. 5 returns.

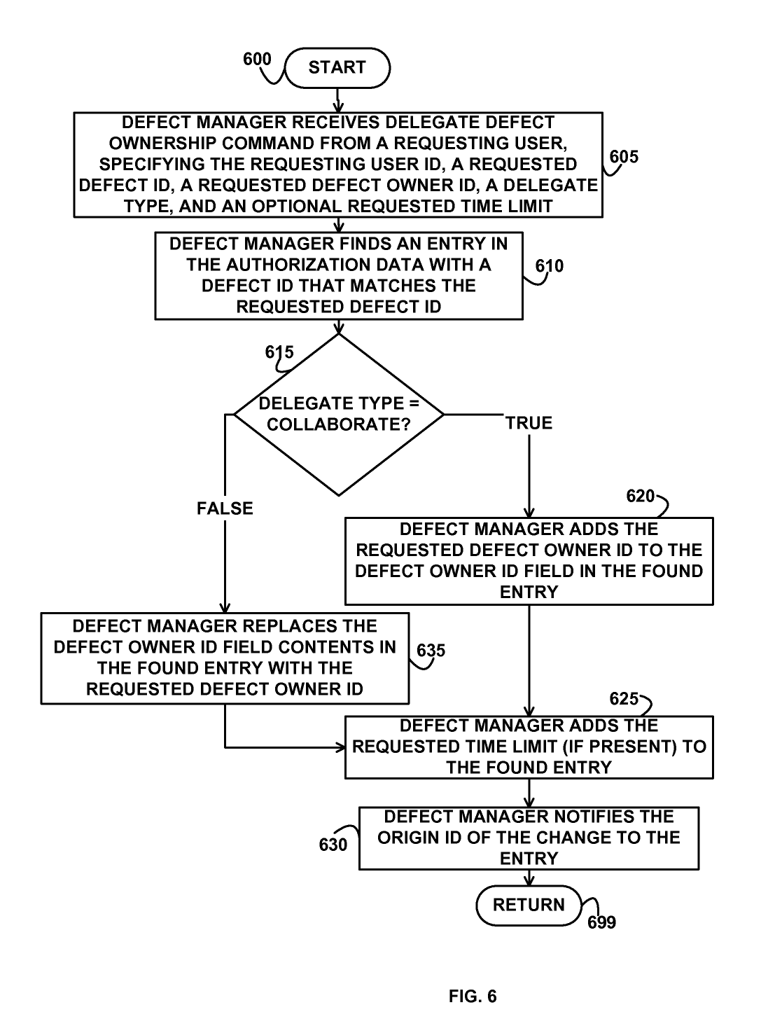

FIG. 6 depicts a flowchart of example processing for delegating authority, according to an embodiment of the invention. Control begins at block 600. Control then continues to block 605 where the defect manager 152 receives a delegate defect ownership command from a requesting user, specifying the requesting user identifier, a requested defect identifier, a requested defect owner identifier, a requested delegate type, and an optional requested time limit.

Control then continues to block 610 where the defect manager 152 finds an entry in the authorization data 158 whose defect identifier 322 matches the requested defect identifier. Control then continues to block 615 where the defect manager 152 determines whether the requested delegate type specifies collaboration.

If the determination at block 615 is true, then the requested delegate type specifies collaboration, so control continues to block 620 where the defect manager 152 adds the requested defect owner identifier to the defect owner identifier field 326 to the found entry in the authorization data 158, which authorizes the requested defect owner to access the part in the same entry while still allowing the previous defect owner identifier to continue accessing the part.

Control then continues to block 625 where the defect manager 152 saves the requested time limit (if present in the request) to the found entry in the authorization data 158. Control then continues to block 630 where the defect manager 152 notifies the user identified by the origin identifier of the change to the entry, e.g., the defect manager 152 sends a message to the requesting user identifier and/or the requested defect owner identifier, indicating that users that are now authorized to access the part. Control then continues to block 699 where the logic of FIG. 6 returns.

If the determination at block 615 is false, then the requested delegate type does not specify collaboration, so control continues to block 635 where the defect manager 152 replaces the defect owner identifier field contents in the found entry of the authorization data 158 with the requested defect owner identifier, which revokes authorization of the previous defect owner identifier and authorizes the requested defect owner identifier to access the part.

Control continues to block 625, as previously described above.

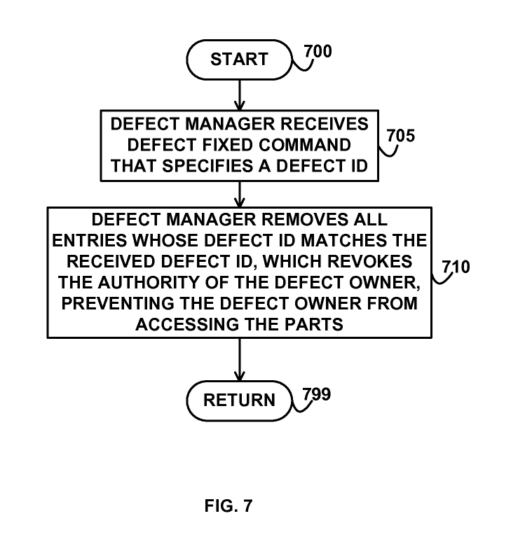

FIG. 7 depicts a flowchart of example processing for a defect fixed command, according to an embodiment of the invention. Control begins at block 700. Control then continues to block 705 where the defect manager 152 receives a defect fixed command that specifies a defect identifier. The defect fixed command indicates that the defect specified by the received defect identifier has been fixed and no longer exists in the product 160. In an embodiment, fixing the defect comprises changing, deleting, or adding instructions or statements in the product 160, so that the unexpected output data of the product 160 no longer exists when the product 160 is executed.

Control then continues to block 710 where the defect manager 152 removes all entries from the authorization data 158 whose defect identifier matches the received defect identifier, which revokes the authority of the defect owner 326 identified in the defect owner identifier field 326 in those entries from accessing the parts identified by the authorized part identifier 324. Control then continues to block 799 where the logic of FIG. 7 returns.

In an embodiment, the logic of FIGS. 4, 5, 6, and 7 execute concurrently or asynchronously from each other.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, embodiments of the invention may be practiced without these specific details. In other instances, well-known circuits, structures, and techniques have not been shown in detail in order not to obscure embodiments of the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense.

What is claimed is:

1. A method comprising:
detecting a defect in a product;
in response to the detecting the defect in the product, creating a part that describes a state of execution of the product at a time that the defect was detected; and
in response to the creating the part that describes the state of execution of the product at the time that the defect was detected, granting authority to access the part to a first user who is responsible for fixing the defect.

2. The method of claim 1, wherein the granting the authority to access the part further comprises:
granting the authority for a period of time.

3. The method of claim 2, further comprising:
revoking the authority in response to expiration of the period of time.

4. The method of claim 1, wherein the granting of the authority to access the part further comprises:
determining the first user who is responsible for fixing the defect from a team to which the first user belongs.

5. The method of claim 1, further comprising:
delegating the authority to access the part from the first user to a second user.

6. The method of claim 5, wherein the delegating authority from the first user to the second user further comprises:
granting the authority to access the part to the second user while the first user retains the authority to access the part.

7. The method of claim 5, wherein the delegating authority from the first user to the second user further comprises:
granting the authority to access the part to the second user and revoking the authority to access the part from the first user.

8. The method of claim 1, further comprising:
in response to the defect being fixed in the product, revoking the authority of the first user who is responsible for fixing the defect to the part.

9. The method of claim 1, wherein the part further describes the defect.

10. A computer-readable storage medium encoded with instructions, wherein the instructions when executed comprise:
detecting a defect in a product;
in response to the detecting the defect in the product, creating a part that describes the defect and describes a state of execution of the product at a time that the defect was detected;
in response to the creating the part that describes the state of execution of the product at the time that the defect was detected, granting authority to access the part to a first user who is responsible for fixing the defect; and
in response to the defect being fixed in the product, revoking the authority of the first user who is responsible for fixing the defect to the part.

11. The computer-readable storage medium of claim 10, wherein the granting the authority to access the part further comprises:
granting the authority for a period of time; and
revoking the authority in response to expiration of the period of time.

12. The computer-readable storage medium of claim 10, wherein the granting of the authority to access the part further comprises:
determining the first user who is responsible for fixing the defect from a team to which the first user belongs.

13. The computer-readable storage medium of claim 10, further comprising:
delegating the authority to access the part from the first user to a second user.

14. The computer-readable storage medium of claim 13, wherein the delegating the authority from the first user to the second user further comprises:
granting the authority to access the part to the second user while the first user retains the authority to access the part.

15. The computer-readable storage medium of claim 13, wherein the delegating the authority from the first user to the second user further comprises:
granting the authority to access the part to the second user and revoking the authority to access the part from the first user.

16. A computer system comprising:
a processor; and
memory communicatively coupled to the processor, wherein the memory is encoded with instructions, and wherein the instructions when executed on the processor comprise
detecting a defect in a product,
in response to the detecting the defect in the product, creating a part that describes the defect and describes a state of execution of the product at a time that the defect was detected,
in response to the creating the part that describes the state of execution of the product at the time that the defect was detected, granting authority to access the part to a first user who is responsible for fixing the defect, wherein the granting of the authority to access the part further comprises determining the first user who is responsible for fixing the defect from a team to which the first user belongs, and
in response to the defect being fixed in the product, revoking the authority of the first user who is responsible for fixing the defect to the part.

17. The computer system of claim 16, wherein the granting the authority to access the part further comprises:
granting the authority for a period of time; and
revoking the authority in response to expiration of the period of time.

18. The computer system of claim 16, wherein the instructions further comprise:
delegating the authority to access the part from the first user to a second user.

19. The computer system of claim 18, wherein the delegating the authority from the first user to the second user further comprises:
granting the authority to access the part to the second user while the first user retains the authority to access the part.

20. The computer system of claim 18, wherein the delegating the authority from the first user to the second user further comprises:
granting the authority to access the part to the second user and revoking the authority to access the part from the first user.
